(19) United States
(12) Patent Application Publication
(10) Pub. No.: US 2009/0304900 A1
(43) Pub. Date: Dec. 10, 2009

(54) BIRD FEED FOR ATTRACTING FINCHES AND OTHER SMALL DESIRABLE BIRDS

(75) Inventor: Bruce Augustin, Marysville, OH (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: OMS INVESTMENTS, INC., Los Angeles, CA (US)

(21) Appl. No.: 12/481,408

(22) Filed: Jun. 9, 2009

Related U.S. Application Data
(60) Provisional application No. 61/060,074, filed on Jun. 9, 2008.

(51) Int. Cl. A23K 1/18

(52) U.S. Cl. 426/630

(57) ABSTRACT

The invention provides various bird feed mixtures that are intrinsically attractive to desirable birds such as finches. The bird feed mixture of the invention attracts larger numbers of desirable birds than commercially available bird feed mixtures. The bird feed mixtures contain thistle, red millet and sunflower chips.

### CROSS-REFERENCE TO RELATED APPLICATIONS

This application claims the benefit under 35 U.S.C. § 119(e) to U.S. Provisional Application Ser. No. 61/060,074, filed Jun. 9, 2008, the entire disclosure of which is hereby incorporated by reference.

### BACKGROUND OF THE INVENTION

(a) Field of the Invention

The invention relates to bird feed mixtures for attracting and feeding finches and other small desirable birds.

(b) Description of the Related Art

Bird watching enthusiasts have long sought to attract birds for observation and enjoyment. A variety of methods and systems have been employed to attract greater numbers of desirable birds, while discouraging undesirable bird species. In particular, bird feed mixtures and bird feeder mechanisms have been developed to attract desirable birds, such as finches.

Numerous bird feed mixtures are known to the art. These bird feed mixtures are composed of varying amounts of different food items typically consumed by birds such as seeds, nuts, fruits, and suet. For example, U.S. Patent Application Publication No. 2006/0127530, discloses a mixture comprising bird feed and a mixture of animal digest to attract birds.

Some bird feed mixtures are designed to be particularly attractive to a given species or category of bird. For example, commercially available bird feed products are marketed as being formulated to attract songbirds such as mockingbirds, robins, carolina wrens, woodpeckers and rose-breasted grosbeaks. See, e.g., Wagner's Orange Raisin-Nut Premium Songbird Blend at the Wagner website (world wide web.wagner.com). Other commercially available bird feed products are marketed as being formulated to attract finches such as Wagner's Finches Deluxe Wild Bird Food and Morning Song Wild Finch Food.

Other methods of attracting small song birds such as finches are also known to the art. Many of these methods depend upon bird feeder mechanisms that exclude undesirable species from gaining access to the bird feed mixture, thereby ensuring that the food is only available to desirable species, such as finches. For example, U.S. Pat. No. 5,970,913, discloses varying the opening size of an expanded metal mesh containing bird feed to select for desirable species. U.S. Pat. No. 4,996,947 discloses a bird feeder that requires birds to feed while hanging upside down, thereby selecting for goldfinches and excluding other birds, such as housefinches, that are not able to feed while upside down.

While these various bird feed mixtures and systems may select for desirable birds, there is still a need for a bird feed mixture that is intrinsically attractive to desirable birds, thereby increasing the number of desirable birds available for observation without regard to the type of bird feeder mechanism used to dispense the food.

### BRIEF SUMMARY OF THE INVENTION

In one aspect, the invention provides a bird feed mixture that is intrinsically attractive to desirable birds such as finches and other small songbirds. In another aspect, the invention provides a bird feed mixture that increases the number of desirable birds available for viewing by bird enthusiasts.

In another aspect, the invention provides a defined bird feed mixture of nyjer (thistle), red millet and sunflower chips. In another aspect, the invention provides for a container, item or package comprising a defined mixture of nyjer (thistle), red millet and sunflower chips. In yet another aspect, the invention provides for a method for producing a bird seed mixture comprising combining thistle, red millet and sunflower chips.

In another aspect, the invention provides a method for feeding birds comprising supplying the bird feed mixture of the invention.

### BRIEF DESCRIPTION OF THE DRAWINGS

FIG. 1 is a view of three feeder socks filled with mixtures of either thistle and red millet, thistle and white millet, or thistle and canary seed.

FIG. 2 is a view of three feeder socks suspended from three hanging stands located 15 feet apart from one another.

FIG. 3 is a diagram of a testing station used to determine bird preferences for thistle versus a mixture of 65% thistle, 25% red millet, and 10% sunflower seed chips by weight (hereinafter “TMC mixture”).

FIG. 4 is a chart comparing the number of bird visits to bird feeders containing the TMC mixture to the number of bird visits to bird feeders containing 100% thistle. The number of non-finch bird visits to feeders containing each type of bird feed mixture is also shown.

FIG. 5 is a view of three types of bird feeders: “finch” feeders, “sock” feeders and “thistle” feeders.

FIG. 6 is a chart comparing the number of bird visits to feeders containing the TMC mixture to the number of bird visits to bird feeders containing 100% thistle, broken down by type of bird feeder (“finch” feeders, “sock” feeders and “thistle” feeders).

FIG. 7 is a chart comparing the number of bird visits to bird feeders filled with the TMC mixture to the number of bird visits to bird feeders filled with Morning Song Wild Finch Food.

FIG. 8 is a chart comparing the number of bird visits to bird feeders filled with the TMC mixture to the number of bird visits to bird feeders filled with Wagner's Finches Deluxe Wild Bird Food.

FIG. 9 is a chart showing a regression analysis of the effect of the percentage of thistle in TMC experimental formulations on the expected number of finches observed, based on the studies discussed in Example 4.

FIG. 10 is a chart showing a regression analysis of the effect of the percentage of red millet in TMC experimental formulations on the expected number of finches observed, based on the studies discussed in Example 4.

FIG. 11 is a graph showing formulations of thistle, red millet, and sunflower seed chips that are expected to perform equivalently to the optimal formulation in attracting small desirable birds. For example, all formulations within the darkest shaded region of the graph have a greater than 95% probability of being as successful as the optimal formulation in attracting small desirable birds.

FIG. 12 is a bar graph showing the average number of finches seen in experimental observation periods for cost-optimized TMC formulation, out-of-range TMC formulation, statistically-optimized TMC formulation, and pure thistle.

### DETAILED DESCRIPTION OF THE PREFERRED EMBODIMENTS

The invention relates to defined bird feed mixtures for attracting and feeding finches and other small desirable birds. In particular, the invention relates to a bird feed mixture consisting essentially of various amounts of nyjer (also referred to as “thistle”), red millet and sunflower seed chips. Surprisingly, it has been found that the bird feed mixture of the invention is more attractive to finches and other small desirable birds than commercially available bird feed mixtures or bird feed formulations composed entirely of thistle.

In one aspect, the bird feed mixture is about 50 to 94% thistle, about 2 to 42% red millet and the balance (to total 100%) sunflower seed chips by weight. For example, if the bird food mixture is about 70% thistle and about 25% red millet, then the mixture will contain about 5% sunflower chips (i.e., 100−(70+25)=5%). More preferably, the bird feed mixture is about 60 to 80% thistle, about 10 to 30% red millet and the balance (to total 100%) sunflower seed chips by weight. Even more preferably, the bird feed mixture is about 63 to 73% thistle, about 10 to 30% red millet and the balance (to total 100%) sunflower chips by weight. Even more preferably, the bird feed mixture is 66 to 68% thistle, about 24 to 28% red millet and the balance (to total 100%) sunflower chips by weight. Most preferably, the bird feed mixture is about 68% thistle, about 26% red millet, and about 6% sunflower seed chips by weight.

In one aspect, the bird feed mixture consists essentially of about 50 to 94% thistle, about 2 to 42% red millet and the balance (to total 100%) sunflower seed chips by weight. More preferably, the bird feed mixture consists essentially of about 60 to 80% thistle, about 10 to 30% red millet and the balance (to total 100%) sunflower seed chips by weight. Even more preferably, the bird feed mixture consists essentially of about 63 to 73% thistle, about 10 to 30% red millet and the balance (to total 100%) sunflower chips by weight. Even more preferably, the bird feed mixture consists essentially of 66 to 68% thistle, about 24 to 28% red millet and the balance (to total 100%) sunflower chips by weight. Most preferably, the bird feed mixture consists essentially of about 68% thistle, about 26% red millet, and about 6% sunflower seed chips by weight.

In another aspect, the bird feed mixture comprises about 50 to 94% thistle, about 2 to 42% red millet and the balance (to total 100%) sunflower seed chips by weight, wherein the bird feed mixture does not contain any other types of seeds. More preferably, the bird feed mixture comprises about 60 to 80% thistle, about 10 to 30% red millet and the balance (to total 100%) sunflower seed chips by weight, wherein the bird feed mixture does not contain any other types of seeds. Even more preferably, the bird feed mixture comprises about 63 to 73% thistle, about 10 to 30% red millet and the balance (to total 100%) sunflower chips by weight, wherein the bird feed mixture does not contain any other types of seeds. Even more preferably, the bird feed mixture comprises 66 to 68% thistle, about 24 to 28% red millet and the balance (to total 100%) sunflower chips by weight, wherein the bird feed mixture does not contain any other types of seeds. Most preferably, the bird feed mixture comprises about 68% thistle, about 26% red millet, and about 6% sunflower seed chips by weight, wherein the bird feed mixture does not contain any other types of seeds.

In another aspect, the bird feed mixture comprises about 50 to 94% thistle, about 2 to 42% red millet and the balance (to total 100%) sunflower seed chips by weight. More preferably, the bird feed mixture comprises about 60 to 80% thistle, about 10 to 30% red millet and the balance sunflower seed chips by weight. Even more preferably, the bird feed mixture comprises about 63 to 73% thistle, about 10 to 30% red millet and the balance sunflower chips by weight. Even more preferably, the bird feed mixture comprises 66 to 68% thistle, about 24 to 28% red millet and the balance sunflower chips by weight.

The bird feed mixtures of the present invention do not include a bird feed mixture of about 65% thistle, about 25% red millet, and about 10% sunflower seed by weight.

Each of the components of the bird feed mixture of the invention are well known components and are readily available.

The bird feed mixture of the invention may be placed in a container, item or package. For example, the bird feed mixture may be packaged for commercial availability.

The bird feed mixture of the invention may be produced in a method comprising combining thistle, red millet and sunflower chips in the amounts set forth above. The invention also provides for a method of feeding birds comprising supplying the bird feed mixture of the invention. The invention also provides for methods of attracting small songbirds, such as finches, comprising placing the bird feed mixture as described herein at a location where said small songbirds will find and consume said bird feed mixture.

### Selection of the Bird Feed Mixture

The components of the bird feed mixture of the invention were selected through preliminary experiments with five of the most common ingredients used in bird feed mixtures intended for feeding finches and other small birds: (1) red millet; (2) thistle; (3) canary seed; (4) white millet; and (5) sunflower seed chips.

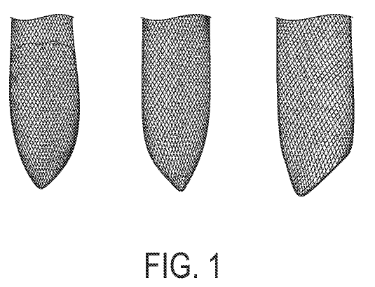

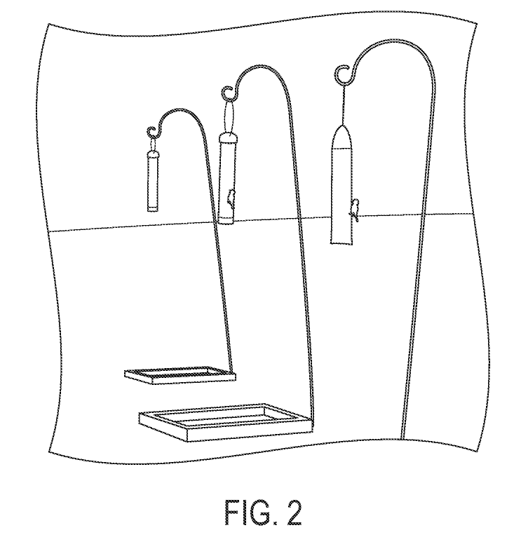

In a first round of preliminary experiments, feeder socks as shown in FIG. 1 were filled with mixtures of either thistle and red millet, thistle and white millet, or thistle and canary seed. The feeder socks were placed on hanging stands and positioned 15 feet apart from one another, as shown in FIG. 2. Two daily counts were conducted to determine the number of bird visits and the types of bird species at each of the three bird feeder stands over the course of 10 days. The experiment was reproduced at three different locations.

The contents of the three feeder socks were analyzed after a 48-hour experimental run in which birds had access to the feeder socks. After 48 hours, it was observed that birds selected only thistle from the sock feeders that contained thistle and white millet or thistle and canary seed mixtures. As a result, white millet and canary seed were excluded as possible ingredients for the bird feed mixture of the present invention.

In a second round of preliminary experiments, three feeder socks as shown in FIG. 1 were filled with either a mixture of thistle, red millet, and sunflower seed chips, a mixture of thistle and red millet, or thistle only. The feeder socks were again placed on hanging stands positioned 15 feet apart from one another, as shown in FIG. 2. Two 30-minute counts were conducted daily to determine the number of bird visits and the types of bird species at each of the three bird feeder stands over the course of 10 days. The experiment was reproduced at three different locations.

The results of the second round of preliminary experiments show that the bird feed mixture containing thistle, red millet, and sunflower seed chips was highly effective at attracting both large numbers of bird visits and large numbers of distinct and desirable species. The results of this round of preliminary experiments are summarized in Table 1.

TABLE 1

| Bird Feed | Number of | |
|---|---|---|
| Mixture Composition | Bird Visits | Number of Distinct Species Visiting |
| Thistle, Red Millet, | 354 | 5 (gold finch, house finch, house |
| and Sunflower | | sparrow, purple finch, and chipping |
| Seed Chips | | sparrow) |
| Thistle and Red | 372 | 4 (gold finch, house finch, chipping |
| Millet | | sparrow, house sparrow)* |
| Thistle Only | 336 | 2 (gold finch, house finch)** |

*Majority of visits were by gold finches and house finches.
**82% of total visits were by gold finches.

A third round of preliminary experiments was carried out to determine relative seed preferences for finches. A first feeder sock was filled with a bird feed mixture of thistle, red millet, and sunflower seed chips. A second feeder sock was filled with a bird feed mixture of thistle and red millet. The two feeder socks were placed 25 feet apart, and birds were allowed to eat for a period of at least 5 minutes. Specimens were then collected and dissected to determine seed preference.

The stomach content of gold finches was 70% thistle, 12% unidentified seeds, 5% red millet, 5% sunflower seed chips, and 8% insects. The stomach content of house finches was 60% thistle, 30% unidentified seeds, 12% red millet, and 8% sunflower seed chips.

This data and further experimentation helped lead to the determination that a mixture of 65% thistle, 25% red millet, and 10% sunflower seed chips by weight (TMC mixture) was surprisingly effective at attracting gold finches and other desirable species, such as, for example, chipping sparrows, house sparrows, and house finches.

The following examples are not intended to limit the invention in any way.

### EXAMPLES

### Example 1

### Comparison of TMC Mixture and 100% Thistle Seed

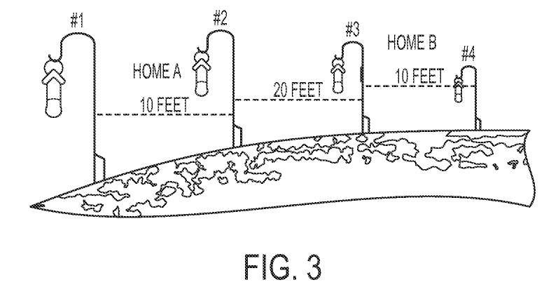

At multiple stations, sets of four bird feeders were established. The stations represented a wide range of environmental habitats with varying vegetation, sound, topography, human presence, water access, animal disturbance and natural predators. At each station, two “Homes” consisting of two bird feeders each were established. The arrangement of each station is illustrated in FIG. 3.

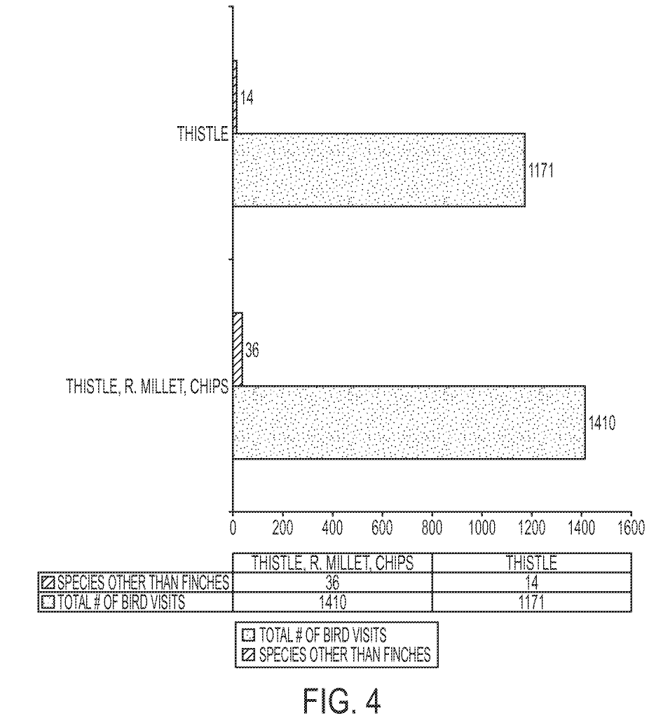

At each station, the two feeders at one of the Homes were filled with 100% Nyjer seed (thistle). The two feeders at the station's other Home were filled with a mixture of 65% thistle, 25% red millet, and 10% sunflower seed chips. Fifteen days of testing were carried out at the six testing stations. During the 15-day survey, 2,581 total bird visits were observed across all six testing stations Some 1,171 bird visits (45.4% of the total) were made to the thistle seed feeders. The remaining 1,410 bird visits (54.6% of the total) were made to the feeders containing the TMC mixture. Thus, the TMC mixture attracted approximately 20% more bird visits than the thistle-only bird feed. Additionally, the TMC mixture attracted 36 bird visits by species other than finches, whereas the thistle-only bird feed attracted only 14 bird visits by species other than finches. The breakdown of bird visits by type of feed mixture is shown in FIG. 4.

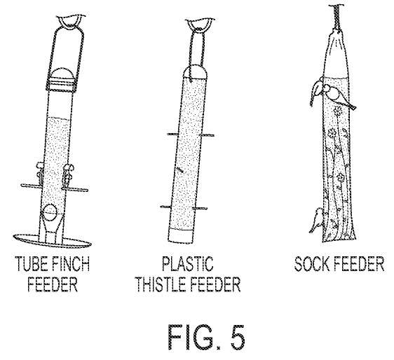

At each of the different stations, different feeder types were used to determine if bird feeder choice affected the number of bird visits. Tube finch feeders, thistle feeders, and sock feeders were used. These bird feeder designs are shown in FIG. 5.

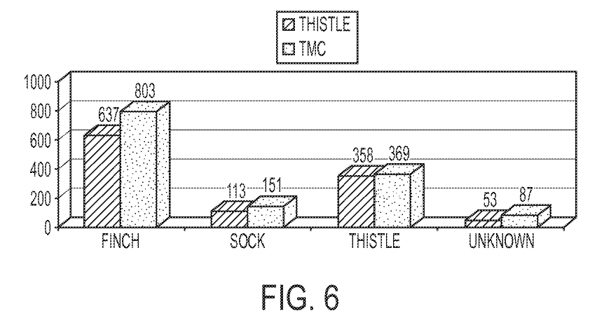

Birds visited feeders containing the TMC mixture more frequently than those feeders that contained 100% thistle regardless of the type of bird feeder used. This result is shown in FIG. 6, which compares bird visits to feeders containing 100% thistle to bird visits to feeders containing the TMC mixture in “finch” feeders, “sock” feeders and “thistle” feeders.

### Example 2

### Comparison of TMC Mixture with Morning Song Wild Finch Food

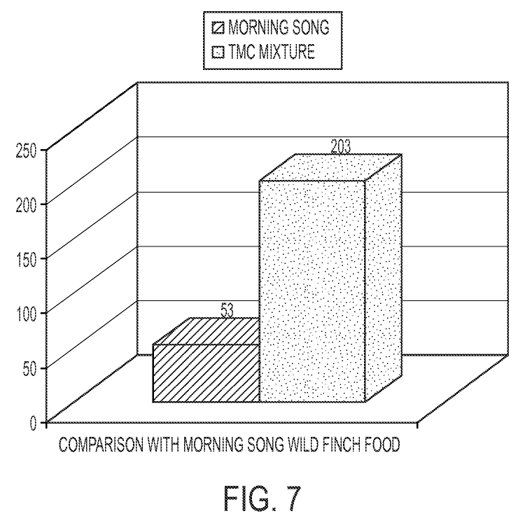

Bird feeders were filled with either the TMC mixture or Morning Song Wild Finch Food. Visits by birds were tallied over the course of three observation periods. The TMC mixture attracted 283% more bird visits (nearly 4 times as many visits) than the Morning Song Wild Finch Food. This result is illustrated in FIG. 7.

### Example 3

### Comparison of TMC Mixture with Wagner's Finches Deluxe Wild Bird Food

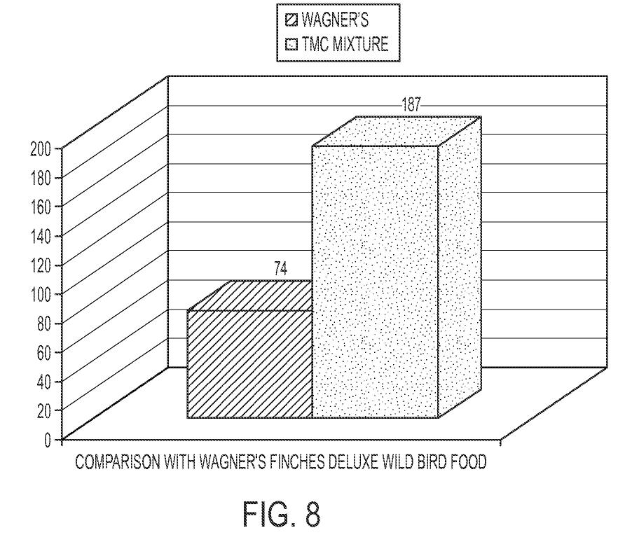

Bird feeders were filled with either the TMC mixture or Wagner's Finches Deluxe Wild Bird Food. Visits by birds were tallied over the course of three observation periods. The TMC mixture attracted 152% more bird visits (nearly 2.5 times as many visits) than Wagner's Finches Deluxe Wild Bird Food. This result is illustrated in FIG. 8.

### Example 4

### Optimization of the TMC Mixture

Additional testing was conducted at locations in Alabama, California, and Ohio. At each location, four bird feeders were established. The feeders were divided into two “Homes” consisting of two bird feeders each. Each of the bird feeders at a given Home was filled with the bird food formulations shown below in Table 2. The feeders were then observed for a six-week period in order to count and identify the birds that visited each of the feeders.

TABLE 2

| | THISTLE | RED MILLET | SUNFLOWER SEED |
|---|---|---|---|
| FORMULATION | (%) | (%) | CHIPS (%) |
| #1 | 43 | 51 | 6 |
| #2 (TMC) | 65 | 25 | 10 |
| #3 | 26 | 59 | 15 |
| #4 | 24 | 31 | 45 |
| #5 | 36 | 17 | 47 |
| #6 | 52 | 9 | 39 |
| #7 | 71 | 8 | 21 |
| #8 | 48 | 33 | 19 |

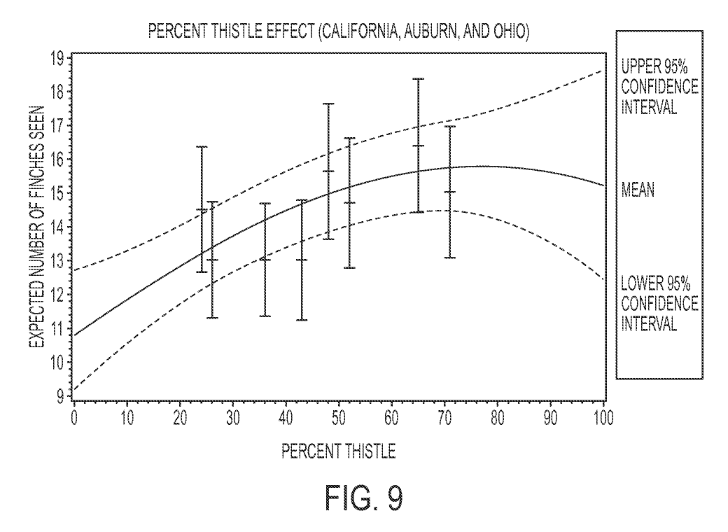

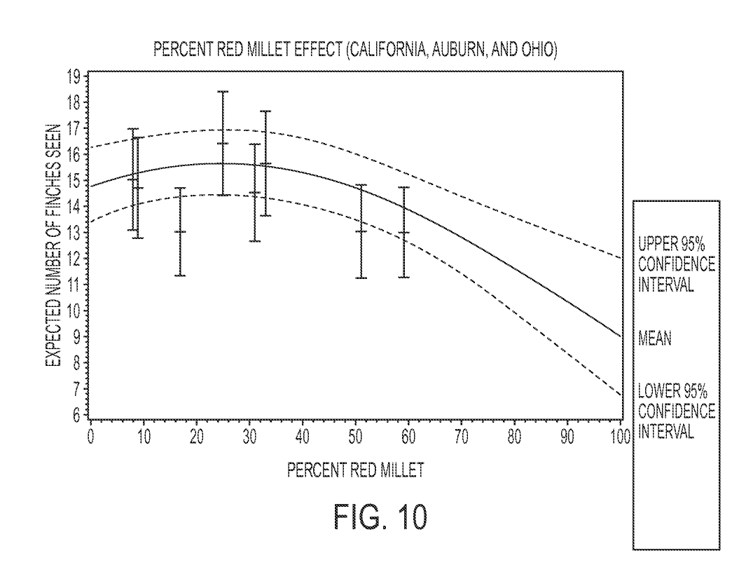

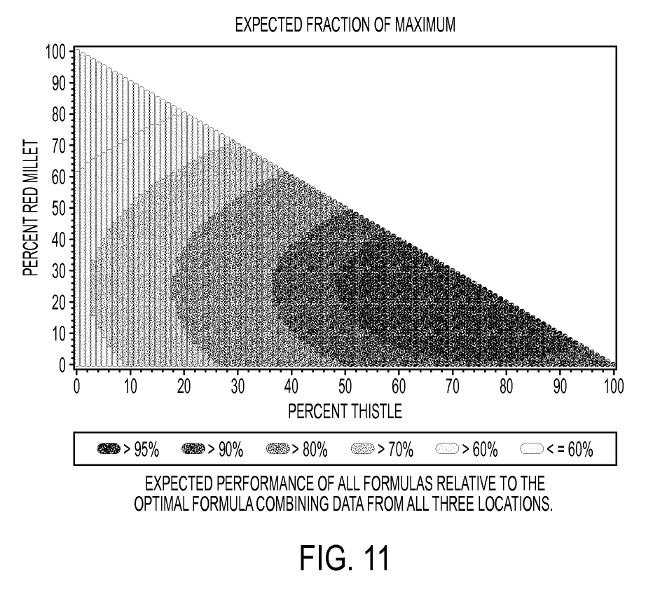

The testing at the three locations included over 14,200 individual feeder observations and over 20,750 individual birds counted at the feeders. Regression analysis of the data collected at the three locations was used to calculate an optimal bird food formulation of 68% thistle, 26% red millet, and 6% sunflower seed chips. Statistical analyses were also used to model the effects of the percentage of thistle and red millet in the bird food formulation on the expected number of finches and other small desirable birds observed during the testing at the three locations. These results are illustrated in FIG. 9 and FIG. 10. Further analysis was used to identify ranges of thistle, red millet, and sunflower seed chip compositions that are statistically likely to perform as well as the optimal formulation. This result is illustrated in FIG. 11. The invention contemplates bird food formulations including at least all of the formulations falling within the >95% region of FIG. 11, including formulations consisting only of thistle and red millet.

### Example 5

### Validation Study of Optimized Formulation

Further testing was conducted to verify the effectiveness of the optimized bird food formulation. These tests were conducted at locations in California, Illinois, and Ohio using four bird feeder stations, with each station consisting of four feeders divided into a “Home A” with two feeders and a “Home B” with two feeders. The bird feeders at a given Home were filled with the same bird food formulation. Different Homes were filled with different bird food formulations. The feeders were then observed for eight days in order to count and identify the birds that visited each of the feeders. The four formulations used in the testing included 100% Nyjer (thistle), the optimized formulation discussed above in Example 4, a cost optimized formulation, and a fourth formulation selected from outside of the 95% confidence region of FIG. 11. These formulations are shown below in Table 3.

TABLE 3

| | THISTLE | RED MILLET | SUNFLOWER SEED |
|---|---|---|---|
| FORMULATION | (%) | (%) | CHIPS (%) |
| #1 | 100 | 0 | 0 |
| #2 | 68 | 26 | 6 |
| (Statistically | | | |
| Optimized) | | | |
| #3 | 55 | 40 | 5 |
| (Cost | | | |
| Optimized) | | | |
| #4 | 10 | 80 | 10 |
| (Out of | | | |
| 95% range) | | | |

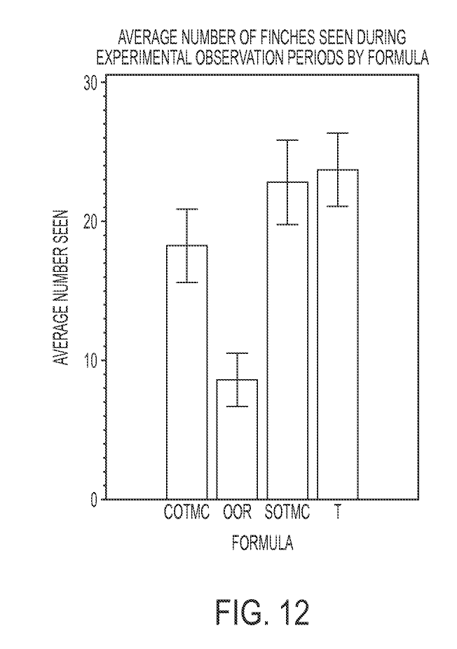

The validation testing included over 3,800 individual feeder observations and over 7,140 individual birds counted at the feeders. The statistically optimized bird food formulation (68% thistle, 26% red millet, and 6% sunflower seed chips) performed significantly better than both the cost optimized formulation and the out-of-95%-range formulation (p<0.001 for both comparisons). The statistically optimized formulation performed 29.1% better at attracting desirable birds than the cost optimized formulation. The statistically optimized formulation also performed 173.2% better at attracting desirable birds than the out-of-95%-range formulation. The cost optimized formulation performed 111.6% better than the out-of-95%-range formulation. Although the statistically optimized formulation was estimated to produce 4.5% fewer desirable bird observations than pure thistle, the difference was not statistically significant. FIG. 12 shows the average number of finches seen in experimental observation periods for cost-optimized TMC formulation, out-of-range TMC formulation, statistically-optimized TMC formulation, and pure thistle.

Although the foregoing invention has been described in some detail by way of illustration and example for purposes of clarity of understanding, it will be obvious that certain changes and modifications may be practiced within the scope of the appended claims. Modifications of the above-described modes for carrying out the invention that are obvious to persons of skill in art are intended to be within the scope of the following claims.

All publications and patents cited in this specification are herein incorporated by reference to the same extent as if each individual publication or patent was specifically and individually indicated to be incorporated by reference.

1. A bird feed mixture, wherein the bird feed mixture is about 50 to 94% thistle, about 2 to 42% red millet, and the balance is sunflower seed by weight, and wherein the bird feed mixture is not about 65% thistle, about 25% red millet, and about 10% sunflower seed by weight.

2. The bird feed mixture of claim 1, wherein the bird feed mixture is about 60 to 80% thistle, about 10 to 30% red millet, and the balance is sunflower seed by weight.

3. The bird feed mixture of claim 1, wherein the bird feed mixture is about 63 to 73% thistle, about 10 to 30% red millet, and the balance is sunflower seed by weight.

4. The bird feed mixture of claim 1, wherein the bird feed mixture is about 66 to 68% thistle, about 24 to 28% red millet, and the balance is sunflower seed by weight.

5. The bird feed mixture of claim 1, wherein the bird feed mixture is about 68% thistle, about 26% red millet, and about 6% sunflower seed by weight.

6. The bird feed mixture of claim 1, wherein the bird feed mixture is about 55% thistle, about 40% red millet, and about 5% sunflower seed by weight.

7. A container, item or package comprising the bird feed mixture of claim 1.

8. A method of producing the bird feed mixture of claim 1, comprising combining thistle, red millet and sunflower chips.

9. A bird feed mixture comprising about 50 to 94% thistle, about 2 to 42% red millet, and the balance is sunflower seed by weight, and wherein the bird feed mixture is not about 65% thistle, about 25% red millet, and about 10% sunflower seed by weight.

10. The bird feed mixture of claim 9, wherein the bird feed mixture comprises about 60 to 80% thistle, about 10 to 30% red millet, and the balance is sunflower seed by weight.

11. The bird feed mixture of claim 9, wherein the bird feed mixture comprises about 63 to 73% thistle, about 10 to 30% red millet, and the balance is sunflower seed by weight.

12. The bird feed mixture of claim 9, wherein the bird feed mixture comprises about 66 to 68% thistle, about 24 to 28% red millet, and the balance is sunflower seed by weight.

13. A container, item or package comprising the bird feed mixture of claim 9.

14. A method of producing the bird feed mixture of claim 9, comprising combining thistle, red millet and sunflower chips.

15. A bird feed mixture, wherein the bird feed mixture comprises about 50 to 94% thistle, about 2 to 42% red millet, and the balance is sunflower seed by weight, and wherein the bird feed mixture is not about 65% thistle, about 25% red millet, and about 10% sunflower seed by weight, and wherein the bird feed mixture does not contain any other types of seeds.

16. The bird feed mixture of claim 15, wherein the bird feed mixture comprises about 60 to 80% thistle, about 10 to 30% red millet, and the balance is sunflower seed by weight, and wherein the bird feed mixture does not contain any other types of seeds.

17. The bird feed mixture of claim 15, wherein the bird feed mixture comprises about 63 to 73% thistle, about 10 to 30% red millet, and the balance is sunflower seed by weight, and wherein the bird feed mixture does not contain any other types of seeds.

18. The bird feed mixture of claim 15, wherein the bird feed mixture comprises about 66 to 68% thistle, about 24 to 28% red millet, and the balance is sunflower seed by weight, and wherein the bird feed mixture does not contain any other types of seeds.

19. A container, item or package comprising the bird feed mixture of claim 15.

20. A method of producing the bird feed mixture of claim 15, comprising combining thistle, red millet and sunflower chips.
